(19) United States
(12) Patent Application Publication
(10) Pub. No.: US 2017/0132682 A1
(43) Pub. Date: May 11, 2017

(54) Method and Apparatus to Automatically Provide Associate Assistance to a Customer

(71) Applicant: Wal-Mart Stores, Inc., Bentonville, AR (US)

(72) Inventors: Matthew A. Jones, Bentonville, AR (US); Nicholaus A. Jones, Fayetteville, AR (US); Robert J. Taylor, Rogers, AR (US)

(21) Appl. No.: 15/336,206

(22) Filed: Oct. 27, 2016

Related U.S. Application Data
(60) Provisional application No. 62/251,469, filed on Nov. 5, 2015.

(51) Int. Cl. G06Q 30/06; G06Q 10/06

(52) U.S. Cl. CPC G06Q 30/0613; G06Q 10/063112

(57) ABSTRACT

A central computer system determines, via a product located in a retail shopping facility, that a customer is engaged with the product. The central computer system then automatically determines an appropriate associate of the retail shopping facility to communicate with that customer regarding the product and instructs that appropriate associate to communicate face-to-face with the customer regarding the product. By one approach, when the assigned associate fails to acknowledge the foregoing instruction, the central computer system determines an alternative appropriate associate and similarly assigns that associate to communicate face-to-face with the customer regarding the product.

### CROSS-REFERENCE TO RELATED APPLICATION

This application claims the benefit of U.S. Provisional Application No. 62/251,469, filed Nov. 5, 2015, and is incorporated herein by reference in its entirety.

### TECHNICAL FIELD

These teachings relate generally to shopping environments and more particularly to devices, systems, and methods for assisting customers in those shopping environments.

### BACKGROUND

In a modern retail store environment, there is a need to improve the customer experience and/or convenience for the customer. Whether shopping in a large format (big box) store or smaller format (neighborhood) store, customers often require assistance that employees of the store are not always able to timely provide. For example, it may not be known or appreciated that a particular customer considering a particular product would benefit from near-term assistance and/or available associates may not all be fully trained or otherwise have access to information to adequately respond to questions regarding particular products.

As a result, a customer can be left with a feeling of uncertainty regarding whether a particular product will meet their needs. Such uncertainty, in turn, can result in a lost opportunity for both the customer and the enterprise. With increasing competition from non-traditional shopping mechanisms, such as online shopping provided by e-commerce merchants and alternative store formats, it can be important for “brick and mortar” retailers to focus on improving the overall customer experience and/or convenience.

### BRIEF DESCRIPTION OF THE DRAWINGS

The above needs are at least partially met through provision of the method and apparatus to automatically provide associate assistance to a customer described in the following detailed description, particularly when studied in conjunction with the drawings, wherein:

FIG. 1 comprises a flow diagram as configured in accordance with various embodiments of these teachings;

FIG. 2 comprises a block diagram as configured in accordance with various embodiments of these teachings; and

FIG. 3 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, the central computer system determines, via a product located in a retail shopping facility, that a customer is engaged with the product. The central computer system then determines an appropriate associate of the retail shopping facility to communicate with that customer regarding the product and instructs that appropriate associate to communicate face-to-face with the customer regarding the product. By one approach, when the assigned associate fails to acknowledge the foregoing instruction, the central computer system determines an alternative appropriate associate and similarly assigns that associate to communicate face-to-face with the customer regarding the product.

These teachings are highly flexible in practice and will accommodate numerous variations as regards the foregoing teachings. For example, when the product has a demonstration mode, the central computer system may determine that the customer is engaged with the product as a function, at least in part, of the product running the demonstration mode. By another approach, when the product includes at least one user-manipulation sensor, the central computer system may determine that the customer is engaged with the product as a function, at least in part, of the customer's manipulation of the product. By yet another approach, when the product includes a user-assertable HELP-request opportunity, the central computer system may determine that the customer is engaged with the product, at least in part, by detecting that the customer has asserted the user-assertable HELP-request opportunity.

By one approach, the central computer system can identify an appropriate associate to communicate with the customer by, at least in part, accessing expertise profiles for a plurality of available associates. So configured, the central computer system can select a particular one of the plurality of available associates likely having a best knowledge of the product based upon the expertise profiles.

So configured, a central computer system for a retail shopping facility can discern, at least in part via a particular product, that a customer requires or may otherwise benefit from a face-to-face interaction with an associate of the retail shopping facility likely having sufficient expertise in relation to the product to provide meaningful information or responses to the customer. These results are attainable in a highly automated fashion and in many cases can help to ensure a quick and suitable response to such a moment and opportunity.

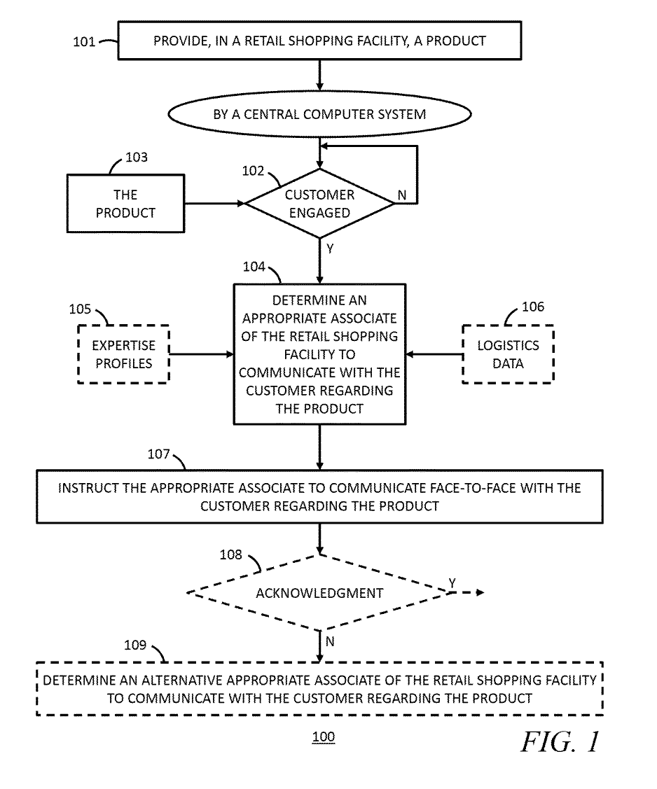

These and other benefits may become clearer upon making a thorough review and study of the following detailed description. Referring now to the drawings, and in particular to FIG. 1, an illustrative process 100 that is compatible with many of these teachings will now be presented. At block 101 this process 100 provides, in a retail shopping facility, at least one product.

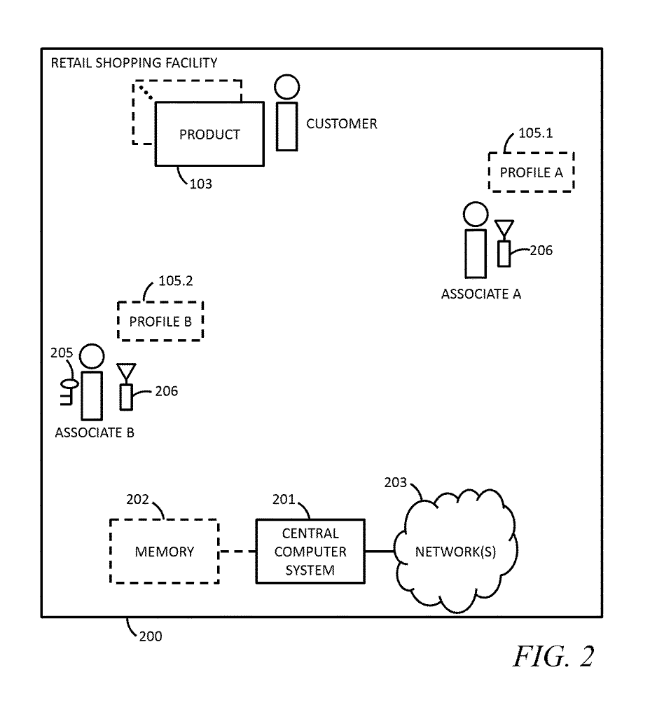

FIG. 2 presents an illustrative example in these regards. In this example the retail shopping facility 200 comprises a retail sales facility or any other type of bricks-and-mortar (i.e., physical) facility in which products 204 are physically displayed and offered for sale to customers who physically visit the facility. The retail shopping facility 200 may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size of format facility, and may include products from one or more merchants. For example, a facility may be a single store operated by one merchant or may be a collection of stores covering multiple merchants such as a mall.

With continued reference to both FIGS. 1 and 2, the remainder of this description will presume that a central computer system 201 carries out the remaining steps, actions, and functionality described herein. The central computer system 201 comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a central computer system 201 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This central computer system 201 is configured (for example, by using corresponding programming as will be well understood by those skilled in the art) to carry out one or more of the steps, actions, and/or functions described herein.

By one optional approach the central computer system 201 operably couples to a memory 202. This memory 202 may be integral to the central computer system 201 or can be physically discrete (in whole or in part) from the central computer system 201 as desired. This memory 202 can also be local with respect to the central computer system 201 (where, for example, both share a common circuit board, chassis, power supply, and/or housing) or can be partially or wholly remote with respect to the central computer system 201 (where, for example, the memory 202 is physically located in another facility, metropolitan area, or even country as compared to the central computer system 201).

In addition to associate profile information as described herein, this memory 202 can serve, for example, to non-transitorily store the computer instructions that, when executed by the central computer system 201, cause the central computer system 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the central computer system 201 also operably couples to one or more communication networks 203. So configured the central computer system 201 can communicate with other elements (both within the retail shopping facility 200 and external thereto) via this/these network(s) 203. Communication networks, including both wireless and non-wireless platforms, are well understood in the art and require no particular elaboration here.

At block 102 the central computer system 201 determines that a customer is engaged with a particular product 103. These teachings are suitable for use with a wide variety of different products including, for example, various personal and business electronic devices such as but not limited to digital cameras, entertainment systems, communication devices, computers, printers, and so forth. That said, these teachings provide specifically for determining the aforementioned engagement via the product 103 itself. This process 100 will accommodate using any of a variety of approaches in these regards.

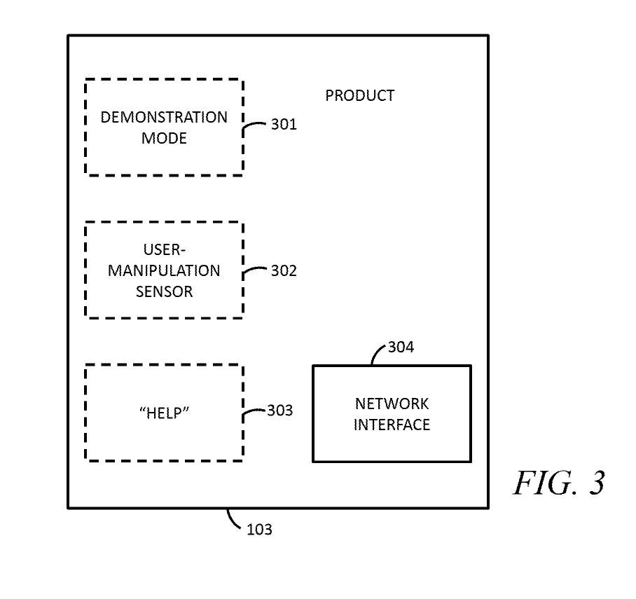

In particular, this process 100 will accommodate products having any of a variety of native capabilities that will support such a notification function. FIG. 3 presents a number of possibilities in these regards. As a first example, the product 103 may have a so-called demonstration mode 301. Demonstration modes are generally known in the art and constitute a visual and/or audible presentation of prerecorded/preprogrammed content that provides, directly or indirectly, information to a customer regarding capabilities, cost, instructions, compatibility, performance, warranties, and so forth regarding the product.

In this case, the demonstration mode 301 will be understood to refer to a demonstration mode that begins in response to a customer's presence. For example, the product 103 may have a thermal and/or proximity sensor to detect the customer's presence. As another example the product 103 may have a touchable user interface to detect the customer's presence. Accordingly, it will be understood that the demonstration mode 301 has a user-triggered state and does not only run either continuously or in a scheduled or random manner that does not depend upon whether a customer is present or not.

In such a case, the central computer system 102 (which communicates with the product 103 via a corresponding network interface 304 that comprises a part of the product 103) can make the aforementioned determination that the customer is engaged with the product 103 as a function, at least in part, of the product 103 running the demonstration mode 301.

As a second example, the product 103 may include one or more user-manipulation sensors 302. Examples in these regards include but are not limited to an accelerometer, a thermal sensor, a proximity sensor, a touchscreen, and so forth. In this case it may be useful or even necessary to install a program on the product 103 that can communicate compatibly with the central computer system 201 regarding inputs experienced by such user-manipulation sensors 302. So configured, the central computer system can make the aforementioned determination that the customer is engaged with the product 103 as a function, at least in part, of the user-manipulation sensor 302 detecting the customer's manipulation of the product.

As a third example, the product 103 may include a user-assertable HELP-request opportunity 303. As used herein this reference to “HELP” will be understood to refer to a request for assistance that is not limited only to the actual word “help” itself. Such an opportunity 303 may comprise, for example, a user-assertable HELP button presented on a touchscreen display as comprises a part of the product 103. These teachings will accommodate other technologies and methodologies as desired. So configured, the central computer system 201 can make the aforementioned determination that the customer is engaged with the product 100 and respond as a function, at least in part, of detecting that the customer has asserted the user-assertable HELP-request opportunity 303 via the aforementioned network interface 304.

It will be understood that the foregoing examples are intended to serve an illustrative purpose and are not intended to constitute an exhaustive listing in these regards.

Upon determining that the customer has engaged in the product 103, at block 104 the central computer system 201 determines an appropriate associate of the retail shopping facility 200 to communicate with the customer regarding that product 103. This determination can be based upon various criteria depending upon the application setting.

By one approach, the central computer system 201 identifies the appropriate associate by, at least in part, accessing expertise profiles 105 for a plurality of available associates. Those expertise profiles 105 may be stored, for example, in the aforementioned memory 202. By way of illustration, FIG. 2 presents an example where associate A has a corresponding profile A 105.1 while associate B has a corresponding profile B 105.2. These expertise profiles can be as detailed and rich as desired.

By one approach, for example, each associate can be questioned or otherwise surveyed regarding their relative personal, academic, and/or business experience with various products and/or types of products. By another approach, in lieu of the foregoing or in combination therewith, these expertise profiles 105 can reflect specific training and/or certification undertaken by the associate as regards specific products or product types. These teachings will readily accommodate other approaches in these regards as desired.

So configured, the central computer system 201 can identify a most appropriate associate by determining from the aforementioned expertise profiles 105 which of the available associates likely has a best knowledge of the product 103.

These teachings will accommodate relying upon other kinds of information in lieu of the foregoing or in combination therewith. As one example in these regards, the central computer system 201 may make this decision, in whole or in part, based upon relevant logistics data 106. This logistics data 106 may indicate, for example, which associate or associates is presently located most closely to the customer/product. In this case, the central computer system 201 may determine that the best associate to dispatch is a first associate having some knowledge of the product who is presently very close to the customer as versus a second associate having deeper knowledge of the product but who is presently very far away from the customer.

As another example, this logistics data 106 may indicate which associates are presently already attending to other tasks. As one illustrative example, the central computer system 201 may determine that the most appropriate associate is an associate who is very knowledgeable of the product 103 and who is also presently engaged in another face-to-face discussion with another customer (as versus other associates who are not presently so engaged but who have no particular expertise with respect to the product in question) when the central computer system 201 also knows that the former associate has been so engaged for a length of time that would suggest that the customer's concerns are likely already at least substantially addressed and that this particular associate may be re-tasked without unduly defeating the purpose of that discussion.

As yet another example, this logistics data 106 may indicate which associates possess a key that is required to unlock a relevant locked product-storage area in the retail shopping facility 200. Referring again to FIG. 2, in this illustrative example associate A possesses no relevant keys while associate B possesses a key 205 that can unlock a storage area where the product 103 is maintained. In this case the central computer system 201 may greatly favor selecting associate B to conduct a face-to-face discussion with the customer regarding the product 103.

Again, it should be understood that these examples are intended to serve an illustrative purpose and are not intended as an exhaustive listing in these regards or to otherwise suggest any particular limitations as to the various kinds of logistical data that can be relied upon in a useful way in a particular application setting.

At block 107 the central computer system 201 instructs the appropriate associate to communicate face-to-face with the customer regarding the product 103. (The expression “face-to-face” is used herein to mean a meeting between two or more people that is conducted in person and in one another's presence rather than at a distance through technology.) By one approach, and as presented in FIG. 2, each associate carries a mobile communications device 206. Depending upon the application setting this mobile communications device 206 can support one-way or two-way voice and/or data communications (including, for example, text-based communications). So configured, the central computer system 201 can convey the aforementioned communication to the determined associate via the aforementioned network 203.

The specific content of this communication can vary with the needs and/or opportunities as tend to characterize a given application setting. By one approach, for example, this communication can provide location information to the appropriate associate as regards the location of the customer/product. That location information can assume any useful form. By one approach, the location information can simply identify a particular department of the retail shopping facility 200 (such as “Entertainment Department” or “Sporting Goods”). By another approach, the location information can be based upon a grid or column-based location system as used by the retail shopping facility 200.

By another approach, in lieu of the foregoing or in combination therewith, this communication can provide information to the associate regarding the particular product 103. If desired, such information can include supplemental information regarding, for example, how many of these products 103 are in present inventory, how quickly this product 103 can be obtained when there is no available inventory, warranty and/or extended warranty information, similar but less expensive offerings, and so forth.

By one optional approach the assigned associate can be expected to respond to such a message with a corresponding acknowledgment message. In that case, at optional block 108 the central computer system 201 can determine whether such an acknowledgment has been received from the assigned associate (for example, within some predetermined window of time).

When such an acknowledgment is not received, at block 109 the central computer system 201 can determine an alternative appropriate associate of the retail shopping facility 200 to communicate with the customer regarding the product 103. This determination can be conducted as described above while presuming that the previously selected associate is presently unavailable for this assignment. Upon making this determination the central computer system 201 can then proceed as described above to assign and notify the alternative associate to conduct the face-to-face discussion with the customer.

So configured, a customer who has demonstrated at least a modicum of interest in a particular product can have a further convenient opportunity to learn more about that product from a suitably-experienced associate. Those skilled in the art will appreciate that these teachings will facilitate assigning a “best suited” associate notwithstanding that the best suited associate is not necessarily assigned to work in the department that displays the product in question. By automatically and quickly providing the benefits of such expertise to a customer at a likely time of need, the customer's perusing and decision-making process can be considerably enriched thereby improving the customer's experience at the retail shopping facility 200.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept. As one example in these regards, these teachings will also accommodate identifying a best associate (or other person) who might be remotely located with respect to the retail shopping facility 200. This person might be, for example, an associate at another retail shopping facility 200, or a person serving outside such a facility as an available expert. In this case the central computer system 201 may arrange for that remotely-located person to provide assistance to the customer via an audio and/or video link supported by the product 103.

What is claimed is:

1. A method comprising:
providing, in a retail shopping facility, a product;
determining, by a central computer system and via the product, that a customer is engaged with the product;
determining, by the central computer system, an appropriate associate of the retail shopping facility to communicate with the customer regarding the product;
the central computer system instructing the appropriate associate to communicate face-to-face with the customer regarding the product.

2. The method of claim 1 wherein the product has a demonstration mode and wherein the central computer system determines that the customer is engaged with the product as a function, at least in part, of the product running the demonstration mode.

3. The method of claim 1 wherein the product includes at least one user-manipulation sensor and wherein the central computer system determines that the customer is engaged with the product as a function, at least in part, of the customer's manipulation of the product.

4. The method of claim 3 wherein the user-manipulation sensor comprises an accelerometer.

5. The method of claim 1 wherein the product includes a user-assertable HELP-request opportunity and wherein the central computer system determines that the customer is engaged with the product, at least in part, by detecting that the customer has asserted the user-assertable HELP-request opportunity.

6. The method of claim 1 wherein the central computer system determines the appropriate associate by, at least in part, accessing expertise profiles for a plurality of available associates.

7. The method of claim 6 wherein the central computer system further determines the appropriate associate by, at least in part, selecting a particular one of the plurality of available associates likely having a best knowledge of the product based upon the expertise profiles.

8. The method of claim 1 wherein the central computer system provides location information to the appropriate associate when instructing the appropriate associate to communicate with the customer.

9. The method of claim 1 further comprising the central computer system receiving an acknowledgment from the appropriate associate.

10. The method of claim 1 further comprising determining an alternative appropriate associate of the retail shopping facility to communicate with the customer regarding the product upon determining that the appropriate associate is presently unavailable.

11. The method of claim 10 wherein the central computer system determines that the appropriate associate is presently unavailable based, at least in part, upon not receiving an acknowledgment from the appropriate associate subsequent to instructing the appropriate associate to communicate with the customer.

12. An apparatus comprising:
a retail shopping facility;
a product displayed in the retail shopping facility;
a central computer system configured to:
determine via the product that a customer is engaged with the product;
determine an appropriate associate of the retail shopping facility to communicate with the customer regarding the product;
instruct the appropriate associate to communicate face-to-face with the customer regarding the product.

13. The apparatus of claim 12 wherein the product has a demonstration mode and wherein the central computer system determines that the customer is engaged with the product as a function, at least in part, of the product running the demonstration mode.

14. The apparatus of claim 12 wherein the product includes at least one user-manipulation sensor and wherein the central computer system determines that the customer is engaged with the product as a function, at least in part, of the customer's manipulation of the product.

15. The apparatus of claim 12 wherein the product includes a user-assertable HELP-request opportunity and wherein the central computer system determines that the customer is engaged with the product, at least in part, by detecting that the customer has asserted the user-assertable HELP-request opportunity.

16. The apparatus of claim 12 wherein the central computer system determines the appropriate associate by, at least in part, accessing expertise profiles for a plurality of available associates.

17. The apparatus of claim 12 wherein the central computer system is further configured to provide location information to the appropriate associate when instructing the appropriate associate to communicate with the customer.

18. The apparatus of claim 12 wherein the central computer system is further configured to receive an acknowledgment from the appropriate associate.

19. The apparatus of claim 12 wherein the central computer system is further configured to determine an alternative appropriate associate of the retail shopping facility to communicate with the customer regarding the product upon determining that the appropriate associate is presently unavailable.

20. The apparatus of claim 19 wherein the central computer system is configured to determine that the appropriate associate is presently unavailable based, at least in part, upon not receiving an acknowledgment from the appropriate associate subsequent to instructing the appropriate associate to communicate with the customer.
